(19) United States
(12) Patent Application Publication
(10) Pub. No.: US 2005/0224322 A1
(43) Pub. Date: Oct. 13, 2005

(54) Multifunctional switch with indicator

(75) Inventors: Kazuhiro Kikuya, Isehara-shi (JP); Kazumasa Tanaka, Tokyo (JP)

Correspondence Address: FOLEY AND LARDNER;SUITE 500, 3000 K STREET NW, WASHINGTON, DC, 20007, US

(73) Assignee: CALSONIC KANSEI CORPORATION

(21) Appl. No.: 11/037,466

(22) Filed: Jan. 19, 2005

(30) Foreign Application Priority Data
Jan. 19, 2004 (JP) P 2004-01025

(51) Int. Cl. H01H 19/58

(52) U.S. Cl. 200/11 R

(57) ABSTRACT

A multifunctional switch with an indicator for selecting and switching a plurality of functions is disclosed. The multifunctional switch is provided with a dial knob capable of being pushed in an axial direction and rotated; a window formed at a center of the dial knob; an indicator configured to indicate a selected function; an indicator support configured to support the indicator and disposed at a rear of the dial knob, the dial knob being rotatably fitted on the indicator support and movable with the indicator support In the axial direction; and means for anti-rotation of the indicator support.

### BACKGROUND OF THE INVENTION

1. Field of the Invention

The present invention relates to a multifunctional switch with an indicator, in which a plurality of functions can be selected by a combination of rotation of a dial knob and an operation of switches.

2. Description of the Related Art

Japanese Patent Application Laid-open No. 2003-054290 discloses a related art of a multifunctional switch with an indicator. According to the related art, the multifunctional switch is provided with a dial knob and a rotary encoder linked with a plurality of switches. Functions can be selected by rotating the dial knob. The dial knob is provided with a translucent window at a center thereof so that an operator can see an indicator (LCD) installed therein.

### SUMMARY OF THE INVENTION

According to the aforementioned related art, the translucent window moves with the dial knob in a case where the dial knob is rotated and hence a relative distance between the translucent window and the indicator is necessarily changeable. Therefore it is necessary to give enough distance therebetween for operation of the dial knob.

Giving enough distance between the translucent window and the indicator leads to a decrease in an area and a drop in clearness for indication of the indicator.

The present invention is intended for providing a multifunctional switch with an indicator, in which a distance between the translucent window and the indicator can be unchangeable and set short so as to give clear view of the indicator.

According to an aspect of the present invention, a multifunctional switch is provided with a dial knob capable of being pushed in an axial direction and rotated; a window formed at a center of the dial knob; an indicator configured to indicate a selected function; an indicator support configured to support the indicator and disposed at a rear of the dial knob, the dial knob being rotatably fitted on the indicator support and movable with the indicator support in the axial direction; and means for anti-rotation of the indicator support.

Preferably, the multifunctional switch is further provided with a first tact switch including repulsive means so as to support and urge the indicator support toward the dial knob.

More preferably, the multifunctional switch is further provided with one or more second tact switches disposed around the dial knob and an indicia plate indicating the functions of the second tact switches, the indicia plate being interposed between the indicator and the dial knob.

Still preferably, the means for anti-rotation of the indicator support is a combination of one or more rails and one or more slots.

### BRIEF DESCRIPTION OF THE DRAWINGS

FIG. 1 is a perspective view of a multifunctional switch with an indicator according to an embodiment of the present invention;

FIG. 2 is an exploded perspective view of the multifunctional switch with the indicator;

FIG. 3 is a cross sectional view, taken from a line III-III of FIG. 1, of the multifunctional switch with the indicator; and

FIG. 4 is a front view of the multifunctional switch with the indicator.

### DETAILED DESCRIPTION OF THE PREFERRED EMBODIMENT

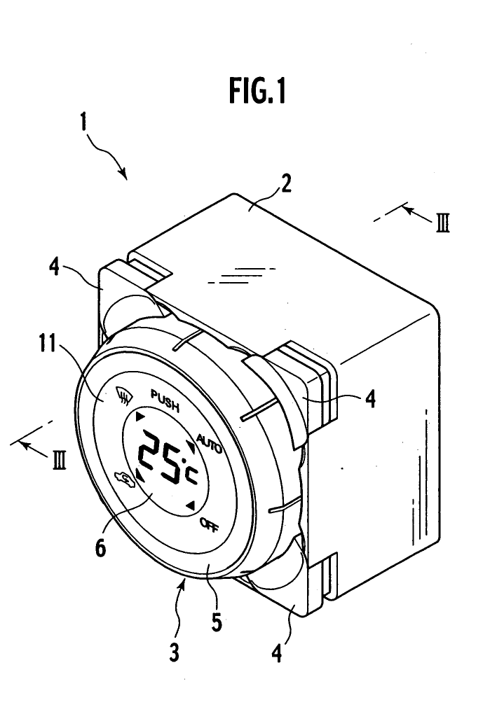

An embodiment of the present invention will be described hereinafter with reference to FIGS. 1 through 4.

A multifunctional switch 1 according to an embodiment of the present invention is applied to an automobile and preferably installed on an instrument panel of the automobile. The multifunctional switch 1 is provided with a casing 2, which has a rectangular cross section, a dial knob 3 disposed in front of the casing 2 and push buttons 4 respectively disposed on four corners of the casing 2 as shown in FIG. 1. The multifunctional switch 1 is installed in the automobile so that the front faces rearward with respect to a direction where the automobile moves.

The dial knob 3 is capable of being rotated and pushed with respect to the casing 2. Switches can be selected by a combination of such rotation and pushing operations. The push buttons 4 are also capable of being pushed with respect to the casing 2.

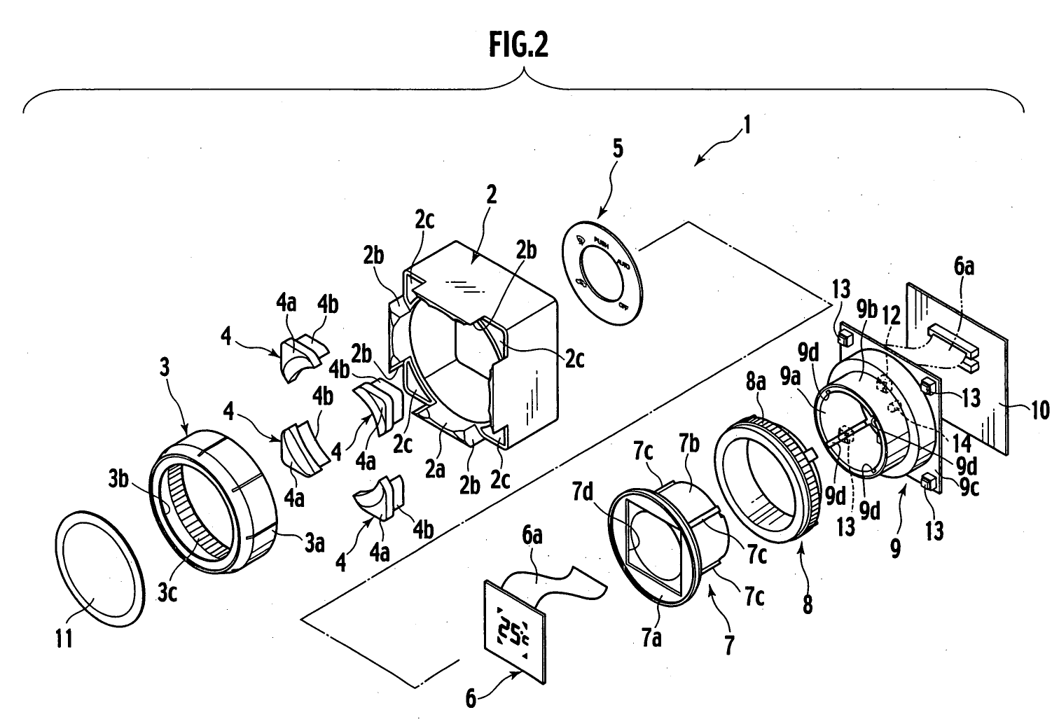

The multifunctional switch 1 is further provided with an indicia plate 5, on which black ink and some signs are printed, a liquid crystal display (LCD) plate 6 for an indicator, an indicator support 7, a transmission ring 8, a rotary encoder 9 and a back substrate 10 housed in the casing 2 as shown in FIG. 2.

The dial knob 3 is provided with a short cylindrical portion 3a and a tapered portion in front of the cylindrical portion 3a. A window 3b is coaxially formed in front of the tapered portion and at a center of the dial knob 3. A lens 11 is engaged in the window 3b. A serration 3c is formed on an inner periphery of the cylindrical portion 3a so as to engage with an outer periphery of the transmission ring 8.

The casing 3 is provided with fitting portions 2a, with which the outer surface of the cylindrical portion 3a of the dial knob 3 rotatably fits. The fitting portions 2a constitute a hypothetical cylindrical surface but four portions thereof, correspondingly to four corners of the casing 3, are cut-off so as to form cut-off sections 2b. Four corners of the casing 3 are respectively provided with insertion portions 2c, to which the push buttons 4 are respectively movably inserted.

Each of the push buttons 4 is provided with a button top 4a, which fits any of the cut-off sections 2b, and a proximal portion 4b, which is movably inserted into any of the insertion portions 2c. The operator utilizes the button top 4a for operation by his or her finger.

The indicator support 7 is disposed at a rear of the dial knob 3. The indicator support 7 is provided with a disk-like flange 7a, with which the dial knob 3 rotatably fits, and a cylindrical portion 7b projecting rearward (forward with respect to the direction where the automobile moves). The cylindrical portion 7b has a plurality of rails 7c (four rails are drawn in FIG. 2) running fore and aft on an outer circumference thereof The indicator support 7 is further provided with a rectangular recess 7d, in which the LCD plate 6 fits.

The LCD plate 6 has a rectangular shape so as to fit with the rectangular recess 7d.

The transmission ring 8 has a ring-like shape so as to fit in the interior of the dial knob 3 and has a serration 8a for engaging with the serration 3c of the dial knob 3. The serrations 3c and 8a are engaged with each other so that rotation of the dial knob 3 is transmitted to the transmission ring 8. The dial knob 3 is prevented from dropping off from the transmission ring 8 by means of anti-dropping means (not shown).

The rotary encoder 9 is provided with an inner fixed cylinder 9a and an outer rotary cylinder 9b. The inner fixed cylinder 9a is fixed with a main substrate 9c which is formed in a rectangular plate shape fitting with the interior of the casing 2. The outer rotary cylinder 9b is rotatably fitted with the inner fixed cylinder 9a and further prevented from axially displacing with respect to the inner fixed cylinder 9a. The rotary encoder 9 is configured to detect a rotation angle of the outer rotary cylinder 9b with respect to the inner fixed cylinder 9a so as to select switches.

The inner fixed cylinder 9a has a plurality of slots 9d (four slots drawn in FIG. 2) on an inner surface thereof. The rails 7c of the indicator support 7 slidably engage with the slots 9d so as to allow axial displacement of the dial knob 3 via the indicator support 7. The combination of the rails 7c and the slots 9d, as well, functions as means for anti-rotation of the LCD plate 6.

The main substrate 9c is provided with a first tact switch 12 and a plurality of second tact switches 13 in a manner that the first tact switch 12 faces to an end of the indicator support 7 and the second tact switches 13 respectively face to ends of the push buttons 4. The tact switches 12 and 13 respectively have return springs built therein. In a state that multifunctional switch 1 is integrated, the tact switches 12 and 13 touch the ends of the indicator support 7 and the push buttons 4 and repulsive forces of the return springs act on the indicator support 7 and the push buttons 4 via the tact switches 12 and 13.

The main substrate 9c is further provided with a back-light 14, to which a LED is applied, for illuminating the LCD plate 6. The back-light 14 is disposed at a center of the rotary encoder 9.

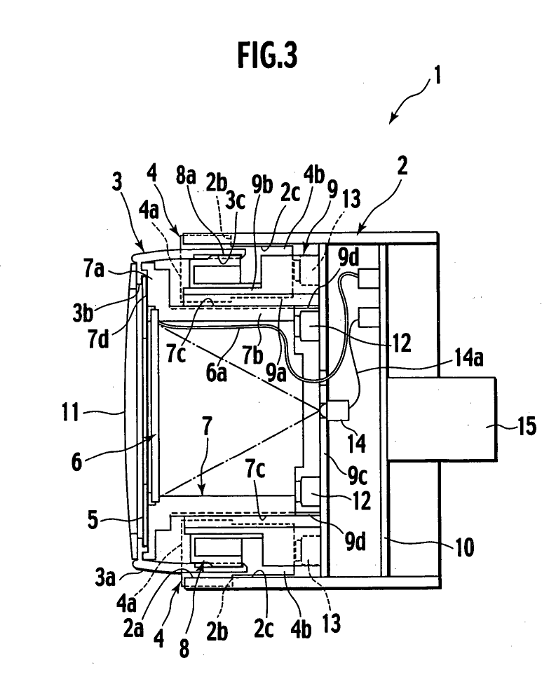

The back substrate 10 is fitted in and closes a substantially rearmost (foremost with respect to the direction where the automobile moves) end of the casing 2. The back substrate 10 is provided with a support projection 15 projecting from a rear surface thereof as shown in FIG. 3. A wiring harness 6a linking with the LCD plate 6 such as FPC and a wiring harness 14a linking with the back-light 14 are led rearward out of the back substrate 10.

The dial knob 3 fits with the disk-like flange 7a of the indicator support 7 with the LCD plate 6 put therebetween. The indicator support 7 is interposed between the dial knob 3 and the first tact switch 12 and hence urged toward the dial knob 3 by the repulsive force of the first tact switch 12.

The indicia plate 5 is interposed between the LCD plate 6 and the dial knob 3 and covers the periphery of the LCD plate 6. The indicia plate 5 is adhered to the LCD plate 6 by an adhesive for anti-rotation.

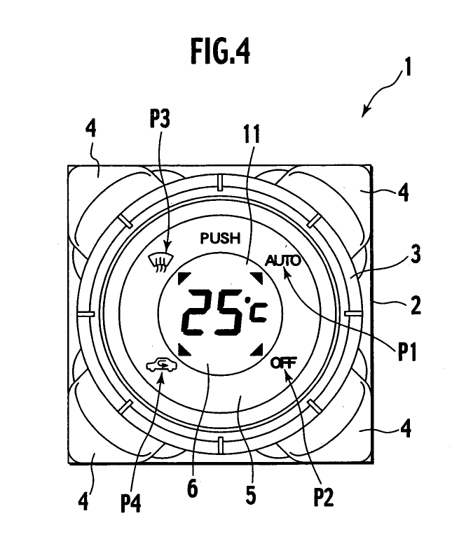

The indicia plate 5 indicates signs of respective functions of the pushbuttons 4 disposed around the dial knob 3. For example, as shown in FIG. 4, the indicia plate 5 indicates “AUTO” at a position P1, “OFF” at a position P2, a pictorial symbol of a defroster at a position P3 and a pictorial symbol of air recirculation at a position P4 with a white ink on a black background. The indicia plate 5 further indicates black triangles for pointing the respective push buttons 4.

When rotating the dial knob 3 the rotary encoder 9 reads the rotation angle and lets the LCD plate 6 indicate the function corresponding to the rotation angle.

By the aforementioned constitution, the first tact switch 12 can be operated by pushing the dial knob 3 via the indicator support 7 and the rotary encoder 9 can be operated by rotating the dial knob 3 via the transmission ring 8. The functions of the switches can be selected by the rotary encoder 9 by means of rotating the dial knob 3.

As being understood from the above description, a relative distance between the dial knob 3 and the LCD plate 6 is kept constant since the LCD plate 6 is supported between the dial knob 3 and the indicator support 7. Therefore the LCD plate 6 can be disposed close to the window 3b of the dial knob 3 and hence a relatively wide area of the LCD plate 6 is present to view through the window 3b. The operator can see the indication of the LCD plate 6 clearly.

Moreover, the constancy of the relative distance provides a freedom of selection of the lens 11. Since the relative distance is constant, any lens having a short focal length can be applied to the lens 11. Thereby the indication of the LCD plate 6 can be more clearly magnified.

Furthermore, in a case of rotating the dial knob 3, the LCD plate 6 is kept in an upright position since the indicator support 7 is anti-rotated with respect to the rotary encoder 9 by means of the combination of the rails 7c and the slots 9d and hence the operator can constantly see the indication in an upright state.

The LCD indicator 6 can be disposed further close to the window 3b of the dial knob 3 since the LCD indicator 6 is urged by the repulsive force of the first tact switch 12.

Particular back-lights for the indicia plate 5 are unnecessary since the indicia plate 5 is interposed between the LCD plate 6 and the dial knob 3 and the back-light 14 illuminates the indicia plate 5 as well as the LCD plate 6. Therefore the number of the back-lights installed therein can be reduced.

An operation feeling of the dial knob 3 can be controlled by properly controlling the coefficient of friction of the indicia plate 5.

The contents of Japanese Patent Application No. 2004-010251 (filed Jan. 19, 2004) are incorporated herein by reference in its entirety.

Although the invention has been described above by reference to certain embodiment of the invention, the invention is not limited to the embodiment described above. Modifications and variations of the embodiment described above will occur to those skilled in the art, in light of the above teachings.

1. A multifunctional switch with an indicator for selecting and switching a plurality of functions, the multifunctional switch comprising:
a dial knob capable of being pushed in an axial direction and rotated;
a window formed at a center of the dial knob;
an indicator configured to indicate a selected function;
an indicator support configured to support the indicator and disposed at a rear of the dial knob, the dial knob being rotatably fitted on the indicator support and movable with the indicator support in the axial direction; and
means for anti-rotation of the indicator support.

2. The multifunctional switch of claim 1, further comprising a first tact switch including repulsive means so as to support and urge the indicator support toward the dial knob.

3. The multifunctional switch of claim 1, further comprising:
one or more second tact switches disposed around the dial knob; and
an indicia plate indicating the functions of the second tact switches, the indicia plate being interposed between the indicator and the dial knob.

4. The multifunctional switch of claim 1, wherein the means for anti-rotation of the indicator support comprises a combination of one or more rails and one or more slots.
